(19) United States
(12) Patent Application Publication
(10) Pub. No.: US 2008/0250021 A1
(43) Pub. Date: Oct. 9, 2008

(54) Method for Searching Private Data Via a Public Data Search Interface

(76) Inventors: Donald Robert Martin Boys, Redding, CA (US); Susan Araiza-Boys, Redding, CA (US)

Correspondence Address: CENTRAL COAST PATENT AGENCY, INC, 3 HANGAR WAY SUITE D, WATSONVILLE, CA, 95076, US

(21) Appl. No.: 12/138,719

(22) Filed: Jun. 13, 2008

Related U.S. Application Data
(63) Continuation-in-part of application No. 11/849,637, filed on Sep. 4, 2007.
(60) Provisional application No. 60/843,250, filed on Sep. 8, 2006.

(51) Int. Cl. G06F 7/00

(52) U.S. Cl. 707/9; 707/E17.059

(57) ABSTRACT

A system for searching data over a network includes a server connected to the network adapted as an interface to users accessing the sever over the network using a computerized appliance, a data repository associated with the server adapted for storing and managing data, and a software interface for accepting a search request from a user. Privately held data managed by third-party content providers is accessed by the system and categorized, summarized, and indexed for search along with publically accessible data normally indexed for data searching and wherein the content providers provide user data to the system including authentication data of users authorized to access the privately held data, the users enabled by the software interface to request search results relative to privately held data the private search results served to the requesting users according to match of authentication data submitted with the request.

### CROSS-REFERENCE TO RELATED APPLICATIONS

The present invention claims priority to a U.S. patent application Ser. No. 11/849,637, filed Sep. 4, 2007 and entitled “Method and Apparatus for Searching Images through a Search Engine Interface Using Image Data and Constraints as Input”, which claims priority to U.S. provisional patent application 60/843,250, filed on Sep. 8, 2006. Disclosure of prior applications are incorporated herein in their entirety by reference.

### BACKGROUND OF THE INVENTION

1. Field of the Invention

The present invention is in the field of network-based data search services and pertains particularly to adding privately held data to a public search index for subscriber search services.

2. Discussion of the State of the Art

In the field of data search services, search service providers routinely crawl the Web to add content to public search index databases to enrich their search capabilities and to provide the public with access to more and more content.

Typically, a search engine company will index content by keyword and use specific algorithms designed to add relevancy to search results returned. Users operating a public search engine type in keywords or phrases often under a search category offered to obtain the search results which include the browser-based location information of the content listing.

Content search interfaces are used in many privately held databases and are made available to subscribing users. One example is genealogy research where a user may subscribe to a database of information related to surnames and may use the search engine to search for the content. There are many other private data stores assembled by different companies who sell access to the content stored therein by subscription. Manufacturing lists, distributor lists, high-level contact data, leads, and other types of marketing information is routinely assembled by companies and then made available by subscription only to paying members. Professional associations also maintain private content that is made available only to members. Likewise, most content available through social interaction networks is privately held data that unless authorized or already available to non-members, is not publically searchable. Still other types of private content include court records, background data on individuals, deeds, foreclosure information and many other types of specialized content.

One limitation to access of privately held data is that users must navigate to the server that accepts the authentication for accessing the data. Some users belong or subscribe to several servers of specialized content that is not publically available through any interface. It would be desirable to users whom subscribe to or otherwise have protected access to privately held content to be able to search that content using a more robust public search interface thereby enjoying the technological advancements relative to filtering the search results to those that are more pertinent to the input provided.

Therefore what is needed is a system and methods for making privately held content searchable to authorized users through a single publically available search interface. A system and methods such as these would eliminate or reduce much work related to navigating to different servers or portals for searching content.

### SUMMARY OF THE INVENTION

A problem stated above is that a user must access more than one interface for data searching if the user desired to search privately-held data that the user has subscribed to one or more content providers to access. Public search interfaces allow the general population to search for data that is generally publically accessible. But if a user has access to private data stores, the user cannot search them from the same interface. The user is required generally to navigate to the content provider site hosting the privately held data and authenticate to search or browse the data.

Every search interface relies on input from a user to enable searching for data. Typically such input is limited to keyword and phrasing used to match to index keywords associated with one or more search results pointing to some data content. It would be desirable for a user having many subscriptions to privately held data sources to include those data sources when searching for public content. However, due to the private nature of the data and the fact that a user generally must compensate a content provider to access private data, the content is never available to a public data search service provider.

The inventor therefore searched software and components of data search systems looking for components that might be leveraged to provide a data search system and publicly accessible interface that could be interacted with to initiate searches of both public and subscription-based private data managed by the content providers.

In an intuitive moment the inventor realized that if a system operated by a system host and service provider could be enabled to provide data search results pointing to privately held data without compromising the privacy nature of the data or the business relationship between the content provider and clients of the provider, clients of more than one provider could benefit by a reduction in work required to search content while content providers might benefit by gaining more clients. The host of the system might also benefit by increasing use of the public interface exposing more users to advertising.

The inventor subsequently conceived and enabled a system that allows clients of multiple content providers hosting privately held data made available to those clients through subscription or other contractual arrangement, to submit a single search request that encompasses public data and all of the privately held data stores they are authorized to search and access. The result was less work for clients and more business for content providers and the system host and service provider.

Accordingly, in one embodiment, the inventor provides a system for searching data over a network comprising a server node connected to the network and executing a set of software code from a digital medium associated thereto, the server node adapted as an interface to users accessing the sever over the network using a computerized appliance running a network browser application executed from a digital medium associated with the appliance; a data repository associated with the server executing a set of software code from a digital medium associated thereto, the repository adapted for storing and managing data; and a software interface provided by the software code executing from the digital medium associated with the first server node for accepting a search request from a user.

Privately held data managed by third-party content providers is accessed by the system and categorized, summarized, and indexed for search along with publically accessible data and wherein the content providers provide user data to the system including authentication data of users authorized to access the privately held data, the users enabled by the software interface to request search results relative to privately held data the private search results served to the requesting users according to match of authentication data submitted with the request.

In a preferred embodiment the network is the Internet and the server node is publically accessible. In one embodiment, the search results are segregated by classification of private or public before service to an authenticated user. In all embodiments the private search results point to content on the network that is made available through subscription or other contractual arrangement to the authenticated users.

In one embodiment the public and private search results are stored separately in the data repository. In another embodiment the public and private search results are mixed together in the repository the results tagged private for private results and public for public results stored in the repository. A search result includes a title, a summary description, the location of the content, and an indication whether the result is public or private. In a preferred embodiment the search results are indexed by relevant keywords and private data is held in an encrypted state relevant at least to human legibility.

According to another embodiment of the invention, the inventor provides a method for enabling a search of network-based private data to be initiated from a public interface accessible on the network comprising the steps (a) accessing privately held data sources and summarizing available content and indexing the content summaries for data search by keyword or other text input, (b) storing the search results for later access, (c) obtaining user data including authentication data from hosts of the privately held content, (d) storing the user data including authentication data for latter access, and (e) providing through a public interface, a search request form including a field for accepting authentication data, the data useable for authentication a user to receive private search results through the public interface.

In a preferred aspect of the method, the network is the Internet and the public interface is a server associated with a digital medium containing software executable there from for providing a public search engine interface. In one aspect, a Web crawler accesses the available content, summarizes the content, and indexes the content. Search result summaries contain, in a preferred embodiment, a title, a summary description of the content, the location of the content and one or more keywords relevant to the content. Also in a preferred aspect, user data includes user identification, a user name or handle, and a password. The search request form is, in one example, an electronic information page nested in a browser frame the page containing interactive fields and controls for initiating a data search.

### BRIEF DESCRIPTION OF THE DRAWING FIGURES

FIG. 1 is an architectural view of a data communications network supporting private data search through a public interface according to an embodiment of the present invention.

FIG. 2 is an exemplary screen shot of a public search interface nested in a browser frame according to an embodiment of the present invention.

FIG. 3 is a process flow chart illustrating steps for ordering a search of private data according to an embodiment of the present invention.

FIG. 4 is a process flow chart illustrating steps for aggregating and returning search results according to an embodiment of the present invention.

FIG. 5 is a process flow chart illustrating steps for preparing a private data source for search from a public interface according to an embodiment of the present invention.

FIG. 6 is an exemplary screen shot of a search result page according to an embodiment of the present invention.

FIG. 7 is an architectural view of a public search services provider according to another embodiment of the present invention.

FIG. 8 is a process flow chart illustrating steps for aggregating and returning search results according to another embodiment of the present invention.

### DETAILED DESCRIPTION

The inventor provides a system and methods for enabling users to search privately held data that they are authorized to search through a public search interface. The present invention is described in enabling detail using the following embodiments.

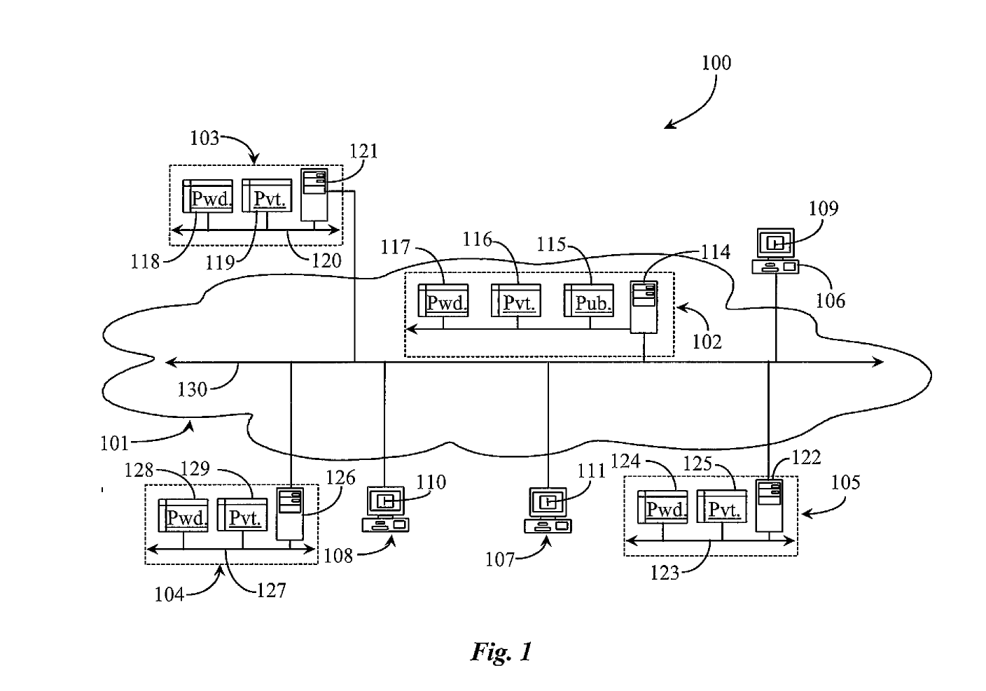

FIG. 1 is an architectural view of a data communications network 100 supporting private data search through a public interface according to an embodiment of the present invention. Communications network 100 is logically illustrated by a network cloud 101 and a network backbone 130. In a preferred embodiment, network 101 is a publically accessible data network such as the Internet network. Network 101 will be referred to hereafter as Internet 101.

Although the invention may be practiced over private wide-area-networks (WAN), the inventor prefers the Internet because of its public accessibility. Network backbone 130 logically represents all of the lines, equipment, and access points that make up the Internet network as a whole including connected sub-networks. Therefore, there are no geographic limitations to the practice of the present invention.

A public data search services provider 102 is illustrated in this example and is connected to network backbone 130 and is accessible over the network. Service provider 102 is adapted to provide data search services to the general public. Examples of companies that provide such services include Google™, Yahoo™, Microsoft™, AltaVista™, Excite™, and a host of others. Provider 102 contains all of the servers, computers, data storage repositories, and software executable from digital mediums associated with the respective hardware to aggregate content over the broader network, index the content for search and provide search results to the public based on typical keyword or phrase search term input. One with skill in the art of data searching is intimately familiar with the generic data search process.

Provider 102 includes at least one server 113 adapted with a digital medium and software as an interface to the public for ordering data search and serving data search results typically in list form in hypertext markup (HTM) or similar formats adapted for browser display. Other servers may also be provided such as portal servers, customer relations management servers and the like as may be required for business. Web crawlers and other search technology mechanisms are not illustrated in this example, but may be assumed present for fulfilling the goals of the provider, that being to index content for data search and to provide search results to users based on input from those users.

Server 113 is connected to a local area network (LAN) 114 that supports at least one data repository 115 adapted with a digital medium and software to store Web-based search result data indexed by keywords as is typical in the art. Repository 115 is adapted to hold search results that point to publically accessible Web-based content (Pub.). Another data repository 116 is provided and is also connected to LAN 114. Repository 116 is adapted to store privately held Web-based search result data (Pvt.). Content is defined relative to search results as minimally the location information to the content the result describes, a content title, and a content summary briefly describing the content that the result points to via the location information. Location information includes universal resource location (URL) and universal resource indicator (URI). Typically a URL hyperlink is provided in a search result to allow a user to interact with the result and navigate the network to the HTML page or wireless application protocol (WAP) page hosting the content located and indexed. Other markup languages may also be used in electronic information pages that host content or access to content. Content may also include that made available as a download through a file transfer protocol site (FTP) or any other file transfer protocol.

Repositories 115 and 116 may be combined and stored in a single repository without departing from the spirit and scope of the present invention as long as the private content is machine distinguishable from the publically accessible content. One method for accomplishing such segregation of content is by tagging one or both content types. One with skill in the art will recognize that a search result tuple typically includes one or more keywords, a title, a content summary or brief description of the content, one or more URLs enabling navigation to the content provided by hyper linking, and. perhaps additional links to related content pages or cached versions of the online resource. A tag such as [Private] or some other flag may be added to private content to distinguish the content from public content for both machines charged with result filtering and humans browsing search result lists.

An additional data repository 117 is provided within provider domain 102 and is connected to LAN 114. Data repository 117 is adapted to store personal passwords (Pwd.), usernames, personal identification codes, and other types of authentication data provided by users. The authentication data stored in repository 117 is associated with each owner or user that provided the information. The data may include authentication credentials to any private data source that a user has access to subject to the correct authentication submission. If a user subscribes to more than one private data source, then there may be more than one set of authentication credentials such as a user name and password for example.

One with any skill in the art will recognize that all of the data types mentioned may reside within a single data repository without departing from the spirit and scope of the present invention. Multiple locations for storing data are illustrated to separate different data types for discussion only. However, one with skill in the art will also appreciate that often multiple repositories and servers are provided for scaling up to enterprise level performance. The exact number of servers and repositories provided is not relevant to the invention.

Authentication data is stored in an encrypted and secure format and is not made available to any third-party human or machine. Moreover, privately-held content stored in repository 116 may also be encrypted and is not made available to any unauthorized users nor is it shared with any third-party human or machine. Server 113 may be assumed to contain software (SW) for providing data search services. The SW is, in one embodiment, enhanced to practice the invention by providing at least one option to users for conducting a search that includes or that is dedicated to privately held data that the user has authorized access to through subscription for example.

A private content provider 103 is illustrated in this example. Content provider 103 is a company that provides privately-held data to users and may make that data searchable for users who are authorized through paid subscription or other compensation arrangement or contract to access the data. Content provider 103 includes an interfacing server 121 adapted with a digital medium and software to enable users to access services. Server 103 is accessible from network backbone 130 and is supported also by a LAN 120. A data repository 119 is illustrated connected to LAN 130 within the domain of service provider 103. Repository 119 is adapted to contain private data that is made available to users through paid subscription or other contract such that a user must submit some authentication credentials in order to search for or browse the private data.

A repository 118 is illustrated within the domain of service provider 103 and connected to LAN 130. Repository 118 is adapted to store user names and passwords used by the company to authenticate users for data access of data from content repository 119. Service provider 103 may maintain all of its own content in repository 119 and may make that content searchable through a proprietary interface or through a custom third-party interface that supports basic data search functions. Such a search interface might be made accessible to users accessing server 121 for services.

Other service provider companies adapted to serve privately-held data to users include a service provider 104, and a service provider 105. Provider 104 includes a LAN 127, an interfacing server 126, a data repository 129 for holding private content, and a password repository 128. Server 126 is accessible to users over Internet 101. Provider 105 includes a LAN 123, an interfacing server 122 connected to backbone 130 and to LAN 123. A private data repository 125 and a password repository 124 are illustrated and are connected to LAN 123. Service providers 103, 104, and 105 may represent largely disparate service organizations. One commonality among them is that users may according to subscription or other contract access these services for the purpose of searching or browsing their data content that is otherwise not available. Another commonality among these services is that they may all have some proprietary Web-based search interface that is available to subscribers or through other contractual arrangement that may be used to access the data stores. It will be appreciated by one with any skill in the art that all servers and repositories contain at least one digital medium therein that may support a set of executable software or firmware instructions.

Computer users 106, 107, and 108 are illustrated in this example and have access to Internet 101 through normal Internet access services through a variety of known methods of access. The invention may be practiced from any computerized network-capable appliance that can support browser-based network navigation. Users 106-108 are not limited to personal computers (PC) for practicing the invention. Computer user 106 has a browser application 109 installed and running thereon. Computer user 107 has a browser application 111 installed and running thereon. Computer user 108 has a browser application 110 installed and running thereon.

Users 106-108 may be subscribers to any number of private data sources that are accessible through connection to Internet 101. User 106 may subscribe to services provided by providers 103 and 105. User 107 may subscribe to services provided by provider 104. User 108 may subscribe to services provided by all three providers, 103, 104, and 105. Any mix is likely.

In practice of the present invention, service provider 102 must have access to private data so that the data can be indexed for search service much in the same way public data is indexed for search. Service provider 102 solicits providers 103, 104, and 105 for permission to access, categorize, and index content available through the respective servers of those providers. Each provider 103, 104, and 105 may also provide a list of usernames and passwords that are currently valid for granting access to private data content.

Each provider of private data 103, 104, and 105 may continue to aggregate and store content for access by subscribers and may still provide localized search services for authenticated users. Service provider 103 may compensate providers 103-105 for participating in enabling their clients to access data through a public search interface. Providers may gain more subscribers by enabling their clients to access data through a public search interface.

From the perspective of a user such as computer users 106-108, the ability to search private data stores from a public search engine reduces much navigation. A user may combine a private and public data search in a single session to include results from privately held data stores and public data stores.

A user like user 106 may log-on to server 113 of service provider 102 and invoke the public search interface provided by software executing on the server from a digital medium in order to initiate a search for content. If the user is a subscriber to private data stores, the user may indicate that individual ones of or all of the user's subscribed-to data stores be included in a search. The search may be dedicated only to the user's specified private data. A user may submit authentication information to access those data stores along with the keyword or phrase input into a search dialog box provided and adapted for the purpose in the public search interface. A dialog box for accepting authentication credentials may be grayed out in the interface until a user indicates that a search of privately-held data will be conducted.

Service provider 102 is authorized to validate user credentials during a search order may matching submitted credentials against those stored in repository 117. Providers 103 through 105 may periodically update username and password lists as they change by submitting the change information to service provider 102 as an update. Service provider 102 and third-party providers 103-105 have a relationship and have prepared for the service to be conducted successfully. A user attempting to submit credentials to search private data from a provider who is not a part of the service will receive an error message such as “provider not recognized”.

A user may submit authentication credentials along with search criteria to receive results including private data results if the privately held data by a third-party provider is indexed for search by service provider 103. In this case the credentials will be matched to those on file for validation purposes. The private results may be segregated from any public search results or they may be combined into one list containing both private and public data results. A user may click on the location link in a private result to navigate to the content in the same way that a user navigates to public content. However, the user's authentication credentials may be asked for by the third-party private data host before the content is actually displayed for the user.

Service provider 102 only retains the private data content title, content summary and location information of the content. The third-party content provider may still authenticate the user before content is served as if the user were accessing the content from the provider's start page. In one embodiment, a user may have a special account with service provider 102 whereby the service provider may “remember” the user's authentication credentials enabling the user to skip the step of submitting them when searching private data. In the case of more than one private data source requiring credentials, to be “remembered” the user may be required to elect search of “all” private data sources when indicating a private data search. Likewise, a general username and password may be issued to the user from service provider 103 that can be associated with the user, usernames and password or PIN credentials.

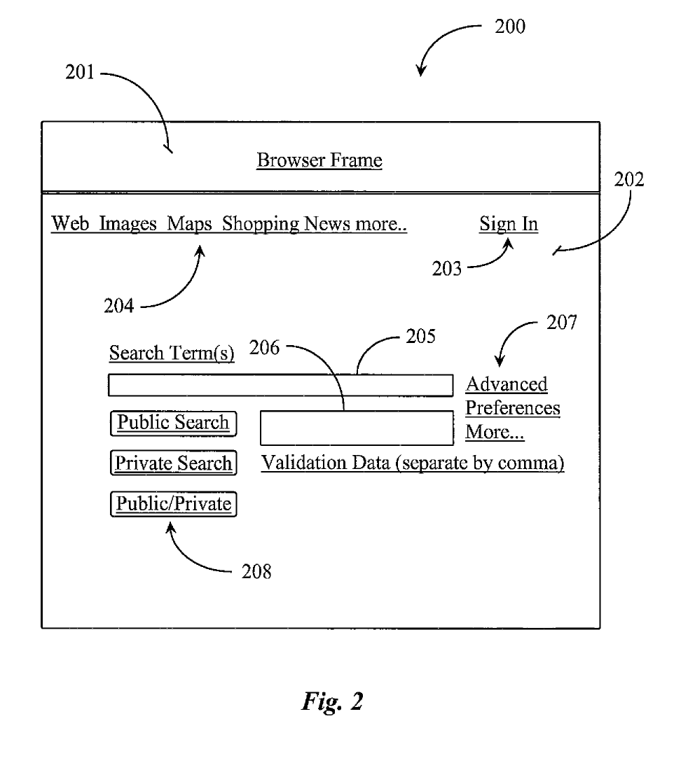

FIG. 2 is an exemplary screen shot of a public search interface 200 nested in a browser frame according to an embodiment of the present invention. Search interface 200 is nested in a browser frame having a browser bar 201 that includes all of the typical browser-based options and menus. Interface 200 displays in window 202 and includes many of the typical options inherent to public search engine interfaces. A user may authenticate to the service provider by using the sign-in option 203 if a user is a subscriber to the search service provider. Interactive filter options 204 are provided for the purpose of ordering a category search. Categories 204 are for We searching and include the categories Images, Maps, Shopping, News, and More. There may be more or fewer categories provided without departing from the spirit and scope of the present invention.

A search term input box 205 is provided on interface 200 for enabling a user to input the typical search term keywords or phrasing to help refine the search. Interface 200 also includes an additional input box 206 adapted to accept the credentials or authentication of user relative to private data subscriptions or contracts. Credentials or validation data sets may be separated by comma like email contacts. Other presentation schemes may also be envisioned. Additional generic search engine options 207 are illustrated and include (from top to bottom) an option for advanced search; an option to include preference rules and other filters and a link to more options.

A task indication interface 208 includes interactive options for staging a search session. Reading from top to bottom Public Search may be invoked to launch a public data search with no private data included. In this case no authentication is required. Next down is a private search icon that can be invoked to specify that the search will be dedicated to private data available only to the authorized and validated user. A third option enables the search to be conducted for public and private data sources. A user may further order the results mixed or shuffled, or the user may get results in a separate window (segregated).

Validation information submitted will be required to match exactly with the information stored in order for the service to initiate a private data search. The authentication credentials; the user's name or handle; and the content provider name associated with the credentials are required in the password database 117 of service provider 102. Content location data is already known to the system for all of the private contents indexed for search.

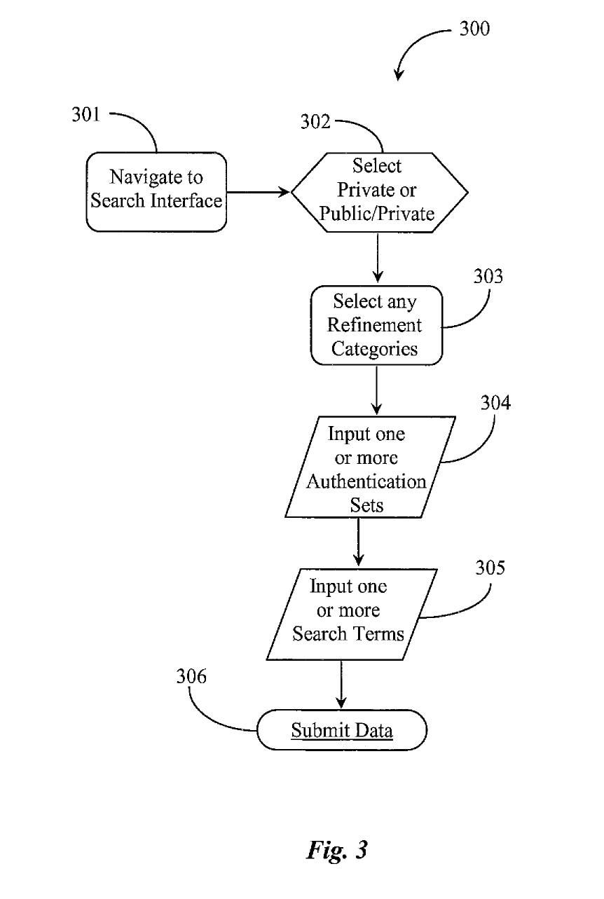

FIG. 3 is a process flow chart illustrating steps 300 for ordering a search of private data according to an embodiment of the present invention. At step 301 a user navigates to a public search interface provided by a service provider adapted to practice the invention. With the interface displayed in the user's browser, the user may select an option private data search or a combination search of public and private data at step 302.

At step 303 the user may continue to select any data search refinement categories like images, audio, news, or the like. At step 304 the user may input one or more authentication data sets that authorize the user to access specific private data the access provided through subscription or other contractual arrangement the user has with a third-party provider or providers. A dialog input field may be provided in the search interface and adapted for the purpose. The authentication data sets may be separated by comma if there is more than one set representing different content providers.

At step 304 the user may input one or more data search terms such as a keyword or phrase. The service provider may enable other types of search input based on the nature of the private data and how that data is generically searched at the third-party host of the data. The search provider may also categorize data and make it searchable in ways that the third-party search interface could not provide for the user through the proprietary search interface normally used at the site.

At step 306 the user submits the data including the search terms and the authentication data. The search terms are used to search the index as id the case with public data indexed. The authentication data is used to validate the user to receive search results relative to the private data sources the user is authorized to access. Steps 303, 304, and 305 do not have to be practiced in any particular order to practice the invention.

One with skill in the art of data searching will recognize that there may be additional steps or sub-routines added to this process without departing from the spirit and scope of the present invention depending on additional services the service provider may make available. For example, a user may select a category and set preferences for file types included in the search.

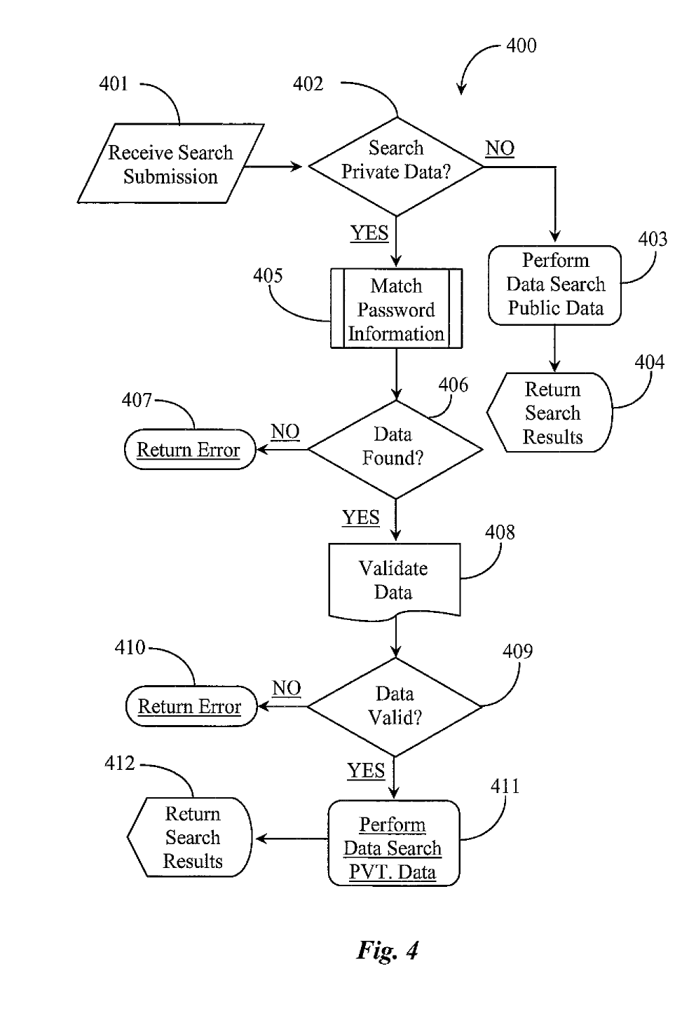

FIG. 4 is a process flow chart illustrating steps 400 for aggregating and returning search results according to an embodiment of the present invention. At step 401 a search service provider adapted to practice the invention receives a search order submission from a user. At step 402 the system determines if private data results will be included in the data search order. There may be an option for ordering a dedicated search of private data and an option for ordering a combination search of public data and one or more private data sources.

If there is no indication for including private data sources in the search, the search service provider performs a public data search at step 403 and returns the results to the user at step 404. If there is an indication that private data will be included or is the focus of the search request received at step 401, the system attempts to match the authentication data or password information to that stored in a password repository at step 405. Authentication or password information may include a user name or handle, email address, or other user ID and a password, a personal identification number (PIN) or some other unique password data. In one embodiment a user name might be a product serial number and the private data might be drivers and software applications that the user is eligible to purchase. It depends on the nature of the private data and the third-party content provider of that data. A unique application exists for commerce sites that enable customers special access to certain data downloads that otherwise they would not be allowed to receive. Such data downloads may include music, SW drivers, E-Books, SW programs, SW patches, tutorials, how-to documents, clipart, photos, and other content types.

At step 406 the system determines if any of or all of the authentication sets resulted in an exact match to sets stored at the service. If no data is found or only one of more than one submitted data sets results in a match, an error may be returned to the user at step 407. One error may state that a content provider cannot be found for this password indicating that the password information is not on file. Another error may state that two of three submitted authentication sets resulted in a match. The system may prompt the user to resubmit the set that did not match to ensure an error in typing did not occur.

At step 406 if the authentication data is found, the system may attempt to validate the data at step 408. This step may be as simple as correlating the matched data to the correct content provider and user name associated with the data in the third-party provider list submitted to the service provider. The service may validate by matching the user name with residual information in the search request like IP address, a cookie, or some other identification data that might reveal the user identification that submitted the request.

It is possible, however unlikely, across content providers to have a same user name and password that might be recorded for two different users having subscriptions to different content providers. In this case, the system may find two separate instances of the same authentication set. A quick validation of IP address, machine serial number, or other accessing device identification may be used to mitigate such circumstances. In one embodiment, a user must submit a full name to the search service provider in order to use private data search services where the user's full name is also stored with the content provider list previously submitted to the search provider.

At step 409 the system determines if the authentication data is valid for the request. If the data matches data stored but cannot be validated to the submitting user then the system may return an error to the user at step 410. The error may state that “We are unable to verify your identity with a content provider for the authentication received”. If at step 409 the system determines that the data submitted is valid, the system performs the data search at step 411 and returns the search results at step 412. At step 411 the system may perform one search in an index containing both private and public search results. Those that match the keywords are filtered according to the authentication sets associated with the content providers that were submitted in the request and subsequently validated by the system.

The search result listing may contain both private data results and public data results. Only private data results are returned if the search was dedicated to one or more private data stores. In one embodiment a user may pre-set a preference for segregating the private results from the public results. Also in one embodiment any private results returned are encrypted relative to content title and summary description until the user navigates to the content page hosting the content and submits his or her authentication data to the third party provider hosting the content. In another embodiment, the private listings may be decrypted by mouse over only to read the result and re-encrypted once the mouse is moved off of the anchor. In one embodiment a virtual tool is provided such as a virtual magnifying glass controlled by the computer mouse. In this embodiment the text or photos within the magnification window are decrypted and magnified as well. As the virtual glass passes over the text or photos, the media reverts to the encrypted state again.

In the later mentioned embodiment, SW may be provided to encrypt private search results with a client application provided to users for the purpose of “on the fly” decryption. The SW installed on the user computer integrates with input drivers for input devices to enable those devices to be used to instantly decrypt text and photos by highlighting text or photos using the input device. A touchpad, mouse, pointer, or keyboard can be used in this way. As soon as the device deselects the target text or photo, the media reverts back to the encrypted state immediately. This way users can quickly browse private or sensitive data without onlookers seeing the actual content. In one embodiment the input device operates with some biometric signature to enable the decryption software so that other users cannot decrypt the private data on the screen.

The service provider hosting the system of the present invention must solicit and cooperate with third-party content providers that host the private data and that make that data available through subscription or other contractual arrangement to their clients.

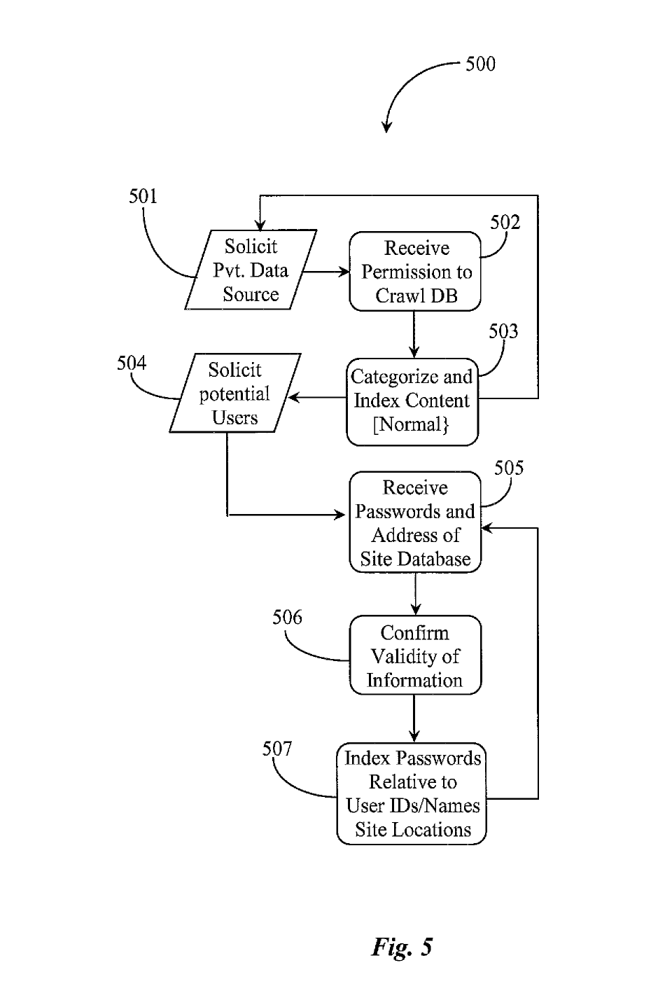

FIG. 5 is a process flow chart illustrating steps 500 for preparing a private data source for search from a public interface according to an embodiment of the present invention. At step 501 a service provider hosting the service of the present invention solicits one or more third-party content providers for permission to Web crawl private data sources and to index the content for search. At step 502 the one or more content providers grant permission to the service provider to access or Web crawl private data sources under their control. The agreement between the service provider and third-party content providers of privately held data may include compensation from the service provider to the content provider(s), or the agreement may be made according to mutual benefit to both parties in advertising revenue and increase of user and subscriber base.

At step 503 the service provider categorizes and indexes the private content for search in the same fashion as it does for public data. One difference may be that private data may be held in encrypted format as described further above. Steps 501 through 503 represent a continuing process continually repeated for new content provider data sources.

At step 504 the service provider solicits potential users of the system of the invention through advertising the new feature for the public search engine. The users have one or more subscriptions to private data source(s) through one or more content providers. Step 504 is a continuing process. The service provider receives lists of usernames and passwords and the location information of the server or servers and Web sites providing access to private data to the authorized clients as part of the agreement at step 505. The authentication information may also include other user identification information like full name, machine address, device serial number, or other electronic ID to tie the user to the correct user name, which may be a handle, and password.

The service provider of step 501 may periodically confirm validity of username and password information received by requesting periodic updates of the information from the content providers at step 506. In this way user no longer registered with those providers may be deleted from the system, new subscribers added to the system, and any password or username changes recorded with the system. Any changes made relative to the subscriber base of a content provider may be updated to the service provider from the content provider including but not limited to changes in service level, authentication data changes, subscription renewal, expiration dates of current subscriptions and other pertinent information that may help maintain and validate authentication data from the point of the service provider. In one embodiment authentication data syncing can be practiced automatically between content providers and the service provider hosting the service of the present invention.

At step 507 the service provider may index or associate authentication data sets (typically username, password) to user electronic IDs, names, and site locations of the Web-sites responsible for granting access to the data. Steps 505 through 507 represent a continuing process. Each username and password entry maintained by the service provider may also be directly correlated to the content provider that forwarded the data to the service provider. In this way other data schemes may be used in the password repository besides storing all authentication sets for one content provider in a cluster or group under that provider, for example. The password data repository may be optimized for fast data search (match) using any one or a combination of known techniques used in data storage management.

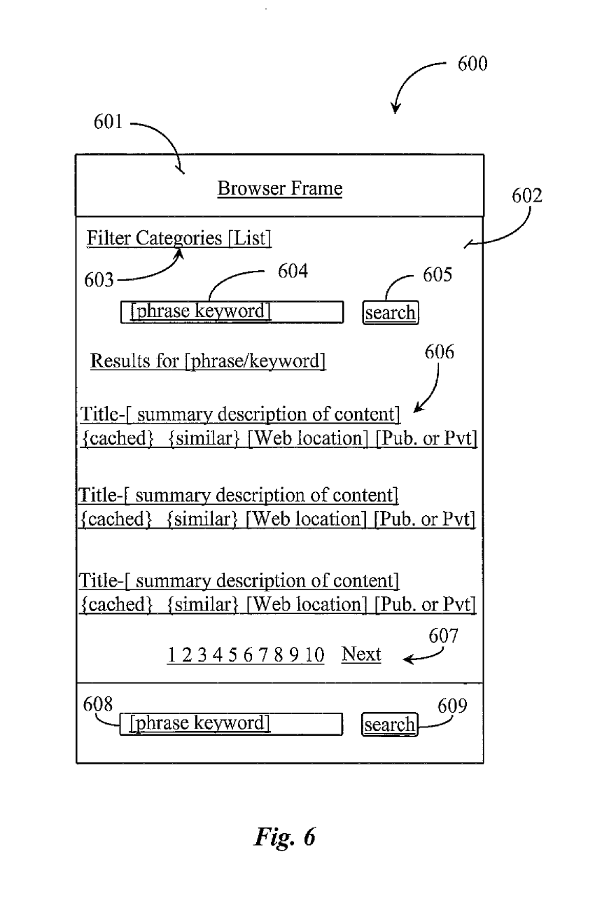

FIG. 6 is an exemplary screen shot 600 of a search result page according to an embodiment of the present invention. Screen shot 600 illustrates a search result page 602 nested in a browser frame 601 much in the same fashion as was described for the search engine interface of FIG. 2.

Result page 602 includes a list 603 of search filter categories. A search input field 604 is provided at the top of page 602 along with a search button 605 for submitting a new or revised search. In the case that a search refinement or new search is requested, the system assumes that the same private data parameters of the original search producing the results on page 602 apply. In this case no authentication input field is illustrated. A user wishing to re-configure the private data aspects of the search may navigate back to the original search interface by hitting the back button on the browser bar. Once the original interface is again displayed the user can reconfigure the private data parameters for a subsequent search request including submission of new authentication data sets, withdrawing current authentication sets from consideration, and so on.

In one embodiment, the authentication data input window may also be provided on the search results page so a user may change parameters working within the data field. Result page 602 contains a list of multiple search results 606 in a fashion that is typically presented to users of search services. Each entry in a list or search results minimally includes a title of the content; a summary description of the resource, indication of any cached pages; indication of any similar public or private pages associated with the result; and the Web location of each result. Search results may be individually tagged to indicate to machine and to human that the result is publically accessible data or if it is privately held data. In this case the option public (Pub.) or private (Pvt.) may be highlighted, flagged, or some other visual indication may exist for each result telling a machine and a user whether a result is public or if it is private.

Search result page has a navigation feature 607 similar to other search interfaces exemplified by the numerical list below and an interactive option to see a next result page listing. One may also interact with the numbers to browse results. A second search input field 608 is provided at the bottom of the page along with a search button for initiating a new or modified data search. In one embodiment of the present invention, the service provider mixes all of the search results together so that both private and public results share the same repository.

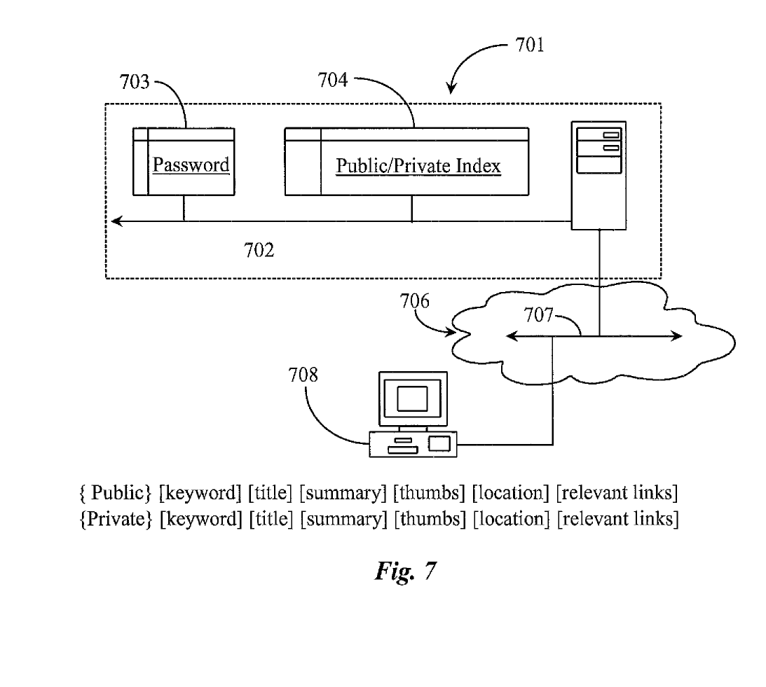

FIG. 7 is an architectural view of a public search services provider 701 according to another embodiment of the present invention. Service provider 701 includes a LAN 702 connected through a server 705 to a network backbone of Internet 706 in the same fashion described above with respect to the service provider of FIG. 1. In this example a data repository 704 is provided and is connected to LAN 702. Repository 704 is adapted to contain both public and private search results mixed together and indexed in the same process for search.

A computer user 708 may log into server 705 and request a search of both private and public data or a search that focuses only on private data. User 708 has Internet access to Internet 706 and server 705. A password repository 703 is provided and connected to LAN 702 in the same fashion previously described with respect to FIG. 1.

Each entry in repository 704 may include a title, summary, thumbs, location, and relevant links along with the keyword(s) used to match the entry in a search of the repository. The difference between public and private data may be noted for each entry by tagging the entry public or private. It is important to note herein that the definition of a search result entry does not necessarily require that all of the data presented in a search result is stored together as a single tuple in the database. In one embodiment an entry matched might include only a title and keyword and an indication of whether the result is public or private. The rest of the data may be associated through correlation schemes in the database software. There are many possibilities. In this embodiment the way that search results are aggregated for a user may be different than that described further above with respect to FIG. 4.

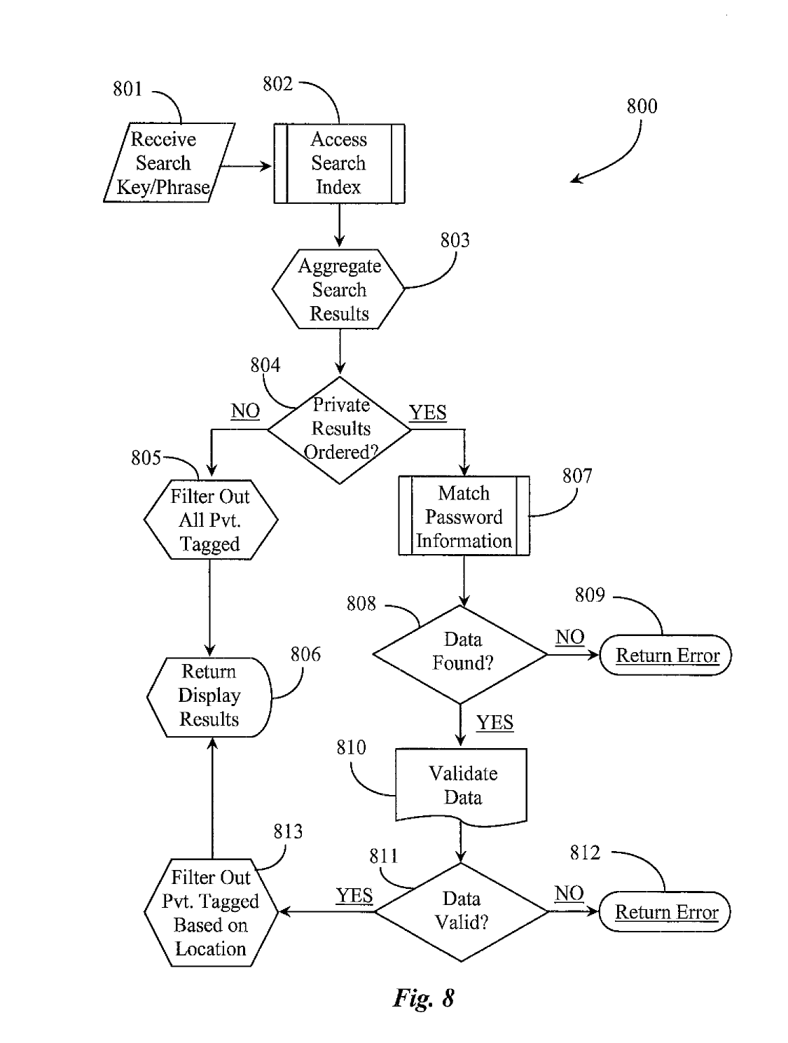

FIG. 8 is a process flow chart illustrating steps 800 for aggregating and returning search results according to another embodiment of the present invention. At step 801 the service provider of the service of the invention receives a search request through the public search interface. The search request will contain one or more keywords used as search terms. The search request will also contain an indication of whether private data results will be searched.

At step 802 the system accesses the search index and searches the index using the keywords or phrasing submitted for the search in the request received at step 801. At this point in the process, no consideration is given to the data result type (private and/or public). The search is conducted as if it were a normal public data search. At step 803 the system locates and aggregates the data search results that matched the search terms submitted with no consideration whether the result contain any private results.

At step 804 the system makes a determination if private data search was part of or was the focus of the search request received. If no search of private data was requested in the request of step 801 then at step 805 all of the results tagged private are filtered our of the aggregation leaving only the public search results. At step 806 the public results are returned to the user and displayed in a search result page at step 806 following the process of a normal search of public data results.

If at step 804 the system determines that private data searching was requested in the request of step 801 then the submitted authentication data is matched against authentication data stored in the system at step 807. At step 808 the system determines if the authentication data was found. The authentication data sets must match exactly to sets stored in the system. If no authentication data was found to match that submitted at step 808, then an error message is returned at step 809. In a case of more than one authentication data set submitted, the system may return an error regarding any of those that the system was not able to match.

If the authentication data submitted matched that stored in the system at step 808 then at step 809 the system may validate that the data actually belongs to the user who submitted the data at step 810. The probability that matching data sets belong to a user that is not the user who submitted the data is very low and lower still if more than one data set is matched. However, validation of the submitting user to the ID associated with the authentication data sets stored may be a default process for enhancing security.

At step 811 the system determines if the data is valid. If the system finds that the data submitted and matched is not valid then at step 812 the system may return an error regarding the invalidated data. If some but not all of the authentication data sets are not validated in the case of more than one set submitted then the error may only be directed to the portion of data that was not validated to the user. If the data matched data stored in the system a typo is highly unlikely. It is more likely that the submitting user stole or was given the password data by the authorized subscriber. The default procedure may be to deny access to private results.

If the authentication data sets submitted and matched to stored data sets is found to be valid to the user in step 811 then the system will filter out the private results that are not associated by location to any of the content provider locations associated with the submitted authentication data. In this step what is left of the private data results are those the user is authorized to receive. The process resolves back to step 806 where the results including the private data results found are returned to the user and displayed in a search result page. Options for segregating private and public results may be available. Private results may be encrypted in display by default whereby the user is enabled by SW to temporarily decrypt the results selected using a computing input device that supports the routine.

It is possible that the keywords or phrasing submitted with an indication to search for private data results do not match any private results even though a user has submitted proper authentication. The system may note that condition by a pop-up window or notice that informs the user that no private results were found. It is also noted that the service provider may not cache actual private content but may only store search result tuples that point to the data on the network. In some cases the user may still be required to provide authentication to actually receive the content from the third party content provider hosting the target content. In another embodiment validation at the service provider for service of private search results carries over to the third party location if the user decides to navigate to the suite and access private content subject of a search result.

It will be apparent to one with skill in the art that the search system and methods of the invention may be provided using some or all of the mentioned features and components without departing from the spirit and scope of the present invention. It will also be apparent to the skilled artisan that the embodiments described above are exemplary of inventions that may have far greater scope than any of the singular descriptions. There may be many alterations made in the descriptions without departing from the spirit and scope of the present invention.

What is claimed is:

1. A system for searching data over a network comprising:
a server node connected to the network and executing a set of software code from a digital medium associated thereto, the server node adapted as an interface to users accessing the sever over the network using a computerized appliance running a network browser application executed from a digital medium associated with the appliance;
a data repository associated with the server executing a set of software code from a digital medium associated thereto, the repository adapted for storing and managing data; and
a software interface provided by the software code executing from the digital medium associated with the first server node for accepting a search request from a user;
characterized in that privately held data managed by third-party content providers is accessed by the system and categorized, summarized, and indexed for search along with publically accessible data and wherein the content providers provide user data to the system including authentication data of users authorized to access the privately held data, the users enabled by the software interface to request search results relative to privately held data the private search results served to the requesting users according to match of authentication data submitted with the request.

2. The system of claim 1 wherein the network is the Internet and the server node is publically accessible.

3. The system of claim 1 wherein the search results are segregated by classification of private or public before service to an authenticated user.

4. The system of claim 1 wherein the private search results point to content on the network that is made available through subscription to the authenticated users.

5. The system of claim 1 wherein the public and private search results are stored separately in the data repository.

6. The system of claim 1 wherein the public and private search results are mixed together in the repository the results tagged private for private results and public for public results stored in the repository.

7. The system of claim 1 wherein a search result includes a title, a summary description, the location of the content, and an indication whether the result is public or private.

8. The system of claim 1 wherein the search results are indexed by relevant keywords.

9. The system of claim 1 wherein private data is held in an encrypted state relevant at least to human legibility.

10. A method for enabling a search of network-based private data to be initiated from a public interface accessible on the network comprising the steps:
(a) accessing privately held data sources and summarizing available content and indexing the content summaries for data search by keyword or other text input.
(b) storing the search results for later access;
(c) obtaining user data including authentication data from hosts of the privately held content;
(d) storing the user data including authentication data for latter access; and
(e) providing through a public interface, a search request form including a field for accepting authentication data, the data useable for authentication a user to receive private search results through the public interface.

11. The method of claim 10 wherein the network is the Internet and the public interface is a server associated with a digital medium containing software executable there from for providing a public search engine interface.

12. The method of claim 10 wherein in step (a) a Web crawler accesses the available content, summarizes the content, and indexes the content.

13. The method of claim 12 wherein the summaries include a title, a summary description of the content, the location of the content and one or more keywords relevant to the content.

14. The method of claim 10 wherein in step (c) user data includes user identification, a user name or handle, and a password.

15. The method of claim 10 wherein in step (e) the search request form is an electronic information page nested in a browser frame the page containing interactive fields and controls for initiating a data search.
